(19) United States
(12) Patent Application Publication
(10) Pub. No.: US 2020/0301008 A1
(43) Pub. Date: Sep. 24, 2020

(54) PRECIPITATION PARTICLE DISCRIMINATOR, PRECIPITATION PARTICLE DISCRIMINATING METHOD, AND PRECIPITATION PARTICLE DISCRIMINATING PROGRAM

(71) Applicant: Furuno Electric Co., Ltd., Nishinomiya (JP)

(72) Inventor: Mariko Hayano, Nishinomiya (JP)

(21) Appl. No.: 16/894,019

(22) Filed: Jun. 5, 2020

Related U.S. Application Data
(63) Continuation-in-part of application No. PCT/JP2018/041905, filed on Nov. 13, 2018.

(30) Foreign Application Priority Data
Dec. 6, 2017 (JP) 2017-234024

(51) Int. Cl. G01S 13/95; G01S 7/41

(52) U.S. Cl. CPC G01S 13/95; G01S 7/41

(57) ABSTRACT

The precipitation particle discriminator includes a radar antenna and processing circuitry. The radar antenna is configured to acquire horizontally polarized reception signals and vertically polarized reception signals by transmitting and receiving horizontally polarized waves and vertically polarized waves, respectively, and the processing circuitry is configured to acquire information on radar reflectivity factors and information on differential reflectivity that are polarization parameters calculated based on the horizontally polarized reception signal and the vertically polarized reception signal, to generate distribution data indicative of relationship between the radar reflectivity information and the differential reflectivity information in a plurality of sampling ranges included in a discrimination target range, to calculate an evaluation value used for discriminating a type of precipitation particles based on the distribution data, and to discriminate the type of the precipitation particles existing in the discrimination target range based on the evaluation value.

### CROSS-REFERENCE TO RELATED APPLICATION(S)

This application is a continuation-in-part of PCT International Application No. PCT/JP2018/041905, which was filed on Nov. 13, 2018, and which claims priority to Japanese Patent Application Ser. No. 2017-234024 filed on Dec. 6, 2017, the entire disclosures of each of which are herein incorporated by reference for all purposes.

### TECHNICAL FIELD

The present disclosure mainly relates to a precipitation particle discriminator which can discriminate a type of precipitation particles such as rain and snow.

### BACKGROUND

Conventionally, a method of discriminating a type of precipitation particles by using a dual polarization radar capable of transmitting and receiving a horizontally polarized wave and a vertically polarized wave, is known. Nonpatent Document 1 discloses this type of method of discriminating precipitation particles.

Nonpatent Document 1 discloses a method of discriminating precipitation particles such as rain particles and snow particles, based on polarization parameters acquired by using a dual polarization. The polarization parameters relate to a radar reflective factor (Zhh), a differential reflective factor (Zdr), a specific differential phase (Kdp), and a correlation coefficient (phv).

### Reference Document of Conventional Art

### Nonpatent Document

### Nonpatent Document 1

Takeharu Kouketsu, Hiroshi Uyeda, Tadayasu Ohigashi, Mariko Oue, Hiroto Takeuchi, Taro Shinoda, and Kazuhisa Tsuboki, 2015: A Hydrometeor Classification Method for X-Band Polarimetric Radar: Construction and Validation Focusing on Solid Hydrometeors under Moist Environments, JOURNAL OF ATMOSPHERIC AND OCEANIC TECHNOLOGY, Vol. 32, pp. 2052-2074

However, in the method disclosed in Nonpatent Document 1, as illustrated in FIG. 1 of the document, since value ranges of polarization parameters acquired from different types of precipitation particles overlap each other, it may be difficult to uniquely distinguish the types of the precipitation particles. Therefore, there is room for an improvement from the perspective of improving the accuracy of discriminating the precipitation particles.

The present disclosure is made in view of the above situations, and a purpose thereof is to provide a precipitation particle discriminator etc. which can accurately discriminate a type of precipitation particles by efficiently using polarization parameters.

### SUMMARY

The problem to be solved by the present disclosure is as described above, and measures to solve the problem and effects thereof are described as follows.

According to the first aspect of the present disclosure, a precipitation particle discriminator with the following configuration is provided. That is, the precipitation particle discriminator includes a radar antenna and processing circuitry. The radar antenna is configured to acquire horizontally polarized reception signals and vertically polarized reception signals by transmitting and receiving horizontally polarized waves and vertically polarized waves, respectively, and the processing circuitry is configured to acquire information on radar reflectivity and information on differential reflectivity that are polarization parameters calculated based on the horizontally polarized reception signal and the vertically polarized reception signal, to generate distribution data indicative of relationship between the radar reflectivity information and the differential reflectivity information in a plurality of sampling ranges included in a discrimination target range, to calculate an evaluation value used for discriminating a type of precipitation particles based on the distribution data, and to discriminate the type of the precipitation particles existing in the discrimination target range based on the evaluation value.

That is, a liquid precipitation particle has the tendency that the value of the differential reflectivity increases as the value of the radar reflectivity increases, while a solid precipitation particle rarely has such a tendency. Therefore, by evaluating the relationship between the two values, the type of the precipitation particles can be discriminated suitably.

The precipitation particle discriminator preferably has the following configuration. That is, the processing circuitry is further configured to extract the radar reflectivity information and the differential reflectivity information in the plurality of sampling ranges included in the discrimination target range within an observation range, from the radar reflectivity information and the differential reflectivity information that are the polarization parameters calculated and acquired by the processing circuitry based on the horizontally polarized reception signals and the vertically polarized reception signals. The processing circuitry is further configured to generate the distribution data based on the radar reflectivity information and the differential reflectivity information.

According to this, since the distribution data is generated based on the radar reflectivity information and the differential reflectivity information in the sampling ranges included in the given discrimination target range within an observation range, the load of data processing can be reduced.

According to the second aspect of the present disclosure, a precipitation particle discriminating method is provided. That is, the method includes acquiring horizontally polarized reception signals and vertically polarized reception signals by transmitting and receiving horizontally polarized waves and vertically polarized waves, respectively. The method includes acquiring information on radar reflectivity and information on differential reflectivity that are polarization parameters calculated based on the horizontally polarized reception signals and the vertically polarized reception signals. The method includes generating distribution data indicative of relationship between the radar reflectivity information and the differential reflectivity information in a plurality of sampling ranges included in a discrimination target range. The method includes calculating an evaluation value used for discriminating a type of precipitation particles based on the distribution data. The method includes discriminating the type of the precipitation particles existing in the discrimination target range based on the evaluation value.

According to the third aspect of the present disclosure, a precipitation particle discriminating program having the following processing is provided. The processing includes generating distribution data based on information on radar reflectivity and information on differential reflectivity that are polarization parameters calculated based on horizontally polarized reception signals and vertically polarized reception signals obtained by transmitting and receiving a horizontally polarized wave and a vertically polarized wave, respectively, the distribution data indicating relationship between the radar reflectivity information and the differential reflectivity information in a plurality of sampling ranges included in a discrimination target range. The processing includes calculating, based on the distribution data, an evaluation value indicating strength of correlation between the radar reflectivity information and the differential reflectivity information. The processing includes discriminating a type of precipitation particles existing in the discrimination target range based on the evaluation value.

According to this, for example, the precipitation particle discriminator can be achieved which can suitably discriminate the type of precipitation particles based on the radar reflectivity information and the differential reflectivity information that are acquired by a device provided separately from the precipitation particle discriminator.

### BRIEF DESCRIPTION OF DRAWINGS

FIG. 1 is a block diagram illustrating a configuration of a weather radar device according to one embodiment of the present disclosure.

FIG. 2 is a plan view schematically illustrating relationship between a determination target range where precipitation particles are discriminated, and observation meshes.

FIGS. 3(a) and (b) are graphs each illustrating distribution data indicative of relationship between values of radar reflective factors and values of differential reflective factors, and an approximated straight line of distribution, in which FIG. 3(a) is a case where precipitation particles are rain particles, and FIG. 3(b) is a case where precipitation particles are snow particles.

FIG. 4 is a scatter plot which explains processing for discriminating between rain and snow by using an average value of the radar reflective factors and an evaluation value.

FIG. 5 is a flowchart illustrating processing executed by a precipitation particle Discriminator.

FIG. 6 is a schematic view illustrating a precipitation particle discriminating system according to a modification.

### DETAILED DESCRIPTION

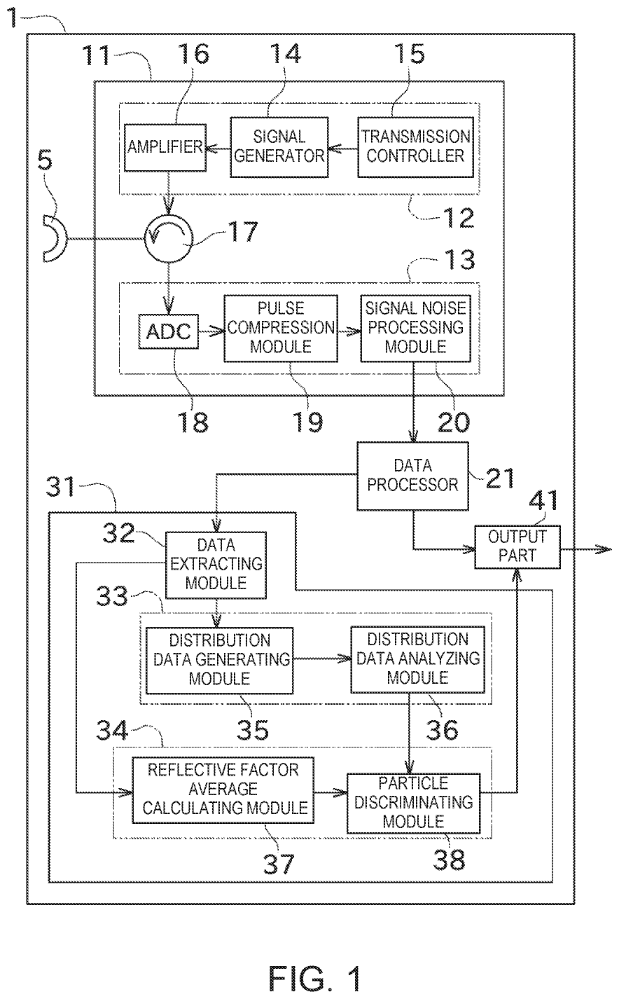

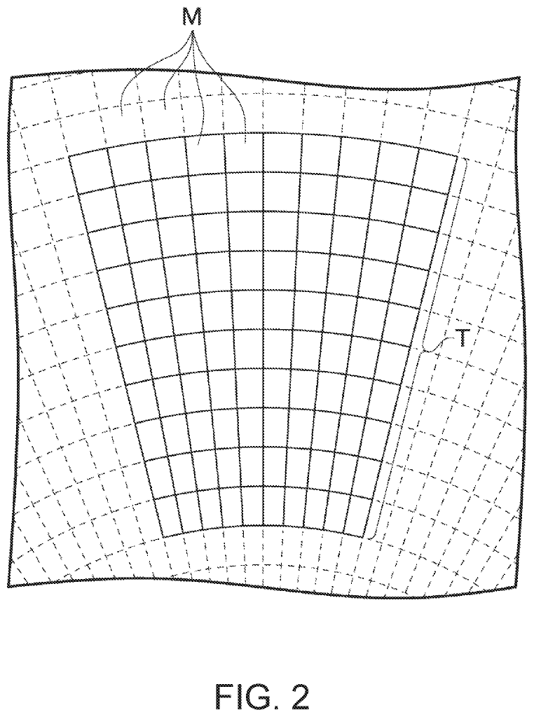

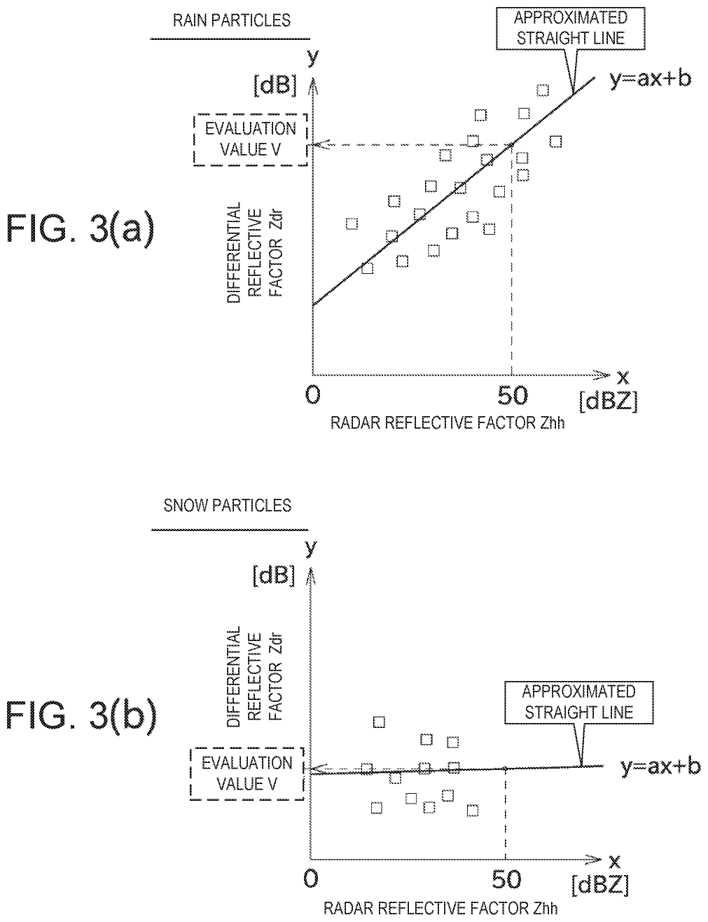

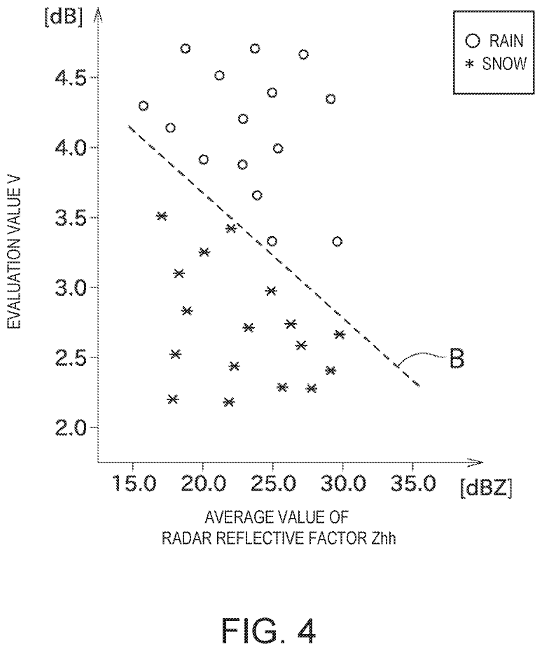

Next, one embodiment of the present disclosure will be described with reference to the drawings. FIG. 1 is a block diagram illustrating a configuration of a weather radar device 1 according to one embodiment of the present disclosure. FIG. 2 is a plan view schematically illustrating relationship between a discrimination target range T where precipitation particles are discriminated, and observation meshes M. FIGS. 3(a) and (b) are graphs each illustrating distribution data indicative of relationship between values of radar reflective factors (which is also referred to a radar reflectivity) Zhh and values of differential reflective factors (which is also referred to a differential reflectivity) Zdr, and an approximated straight line of the distribution. FIG. 3(a) is a case where precipitation particles are rain particles, and FIG. 3(b) is a case where precipitation particles are snow particles. FIG. 4 is a scatter plot which explains processing for discriminating between rain and snow by using an average value of the radar reflective factors Zhh and an evaluation value V.

The weather radar device 1 (precipitation particle discriminator) illustrated in FIG. 1, can acquire data related to weather in a given space (hereinafter, referred to as an “observation range”), for example, by transmitting and receiving radio waves in a frequency band of X-band while rotating an antenna 5. The weather radar device 1 may be comprised as a dual polarization radar, and transmit two types of radio waves (a horizontally polarized wave and a vertically polarized wave) so that various data can be observed. Such a radar is called a “multi-parameter radar.”

This weather radar device 1 may include a radar (acquiring part (which is also referred to a radar antenna)) 11, a data processor 21, a discriminator 31, and an output part 41. The data processor 21 and the discriminator 31 may also be referred collectively to as processing circuitry 999.

The radar 11 may actually transmit and receive a radio wave to/from the observation range, and output to the data processor 21 a signal based on the received radio wave.

The data processor 21 may receive an input of the signal outputted from the radar 11, and calculate various polarization parameters. The data processor 21 may output the acquired polarization parameters to the discriminator 31 and the output part 41.

The discriminator 31 may comprise a part of the weather radar device 1, and have a function to discriminate the precipitation particles. The discriminator 31 may discriminate a type of precipitation particles when the discrimination target range T specified in the observation range has precipitation. The discriminator 31 may output a result of the discrimination to the output part 41.

The output part 41 may output the various polarization parameters obtained by the data processor 21, and the discrimination result obtained by the discriminator 31 to an external storage device etc. This output part 41 may include a wired or wireless communication interface.

The discriminator 31 may be implemented by a computer of a known configuration, similarly to the data processor 21 and the output part 41. This computer may include a CPU, a ROM, a RAM, and an input/output interface. The ROM may store, for example, a program for implementing a method of discriminating precipitation particles according to the present disclosure. By the hardware and the software described above working together, the computer can be implemented as the discriminator 31, the data processor 21, the output part 41, etc.

Description is given about the radar 11. The radar 11 may include a transmission signal output part 12, the antenna 5, and a reception signal processor 13.

The transmission signal output part 12 may output a transmission signal to the antenna 5. The transmission signal output part 12 may include a signal generator 14, a transmission controller 15, and an amplifier 16. The signal generator 14 may generate a transmission signal and output it to the amplifier 16. Note that a timing of outputting the transmission signal may be controlled by the transmission controller 15. The transmission signal outputted by the signal generator 14 may be amplified by the amplifier 16, and then outputted to the antenna 5 via a circulator 17.

The antenna 5 may transmit a radio wave as the transmission signal to the observation range, as well as receive a reflection wave which is a reflection of the radio wave on precipitation particles, etc. The antenna 5 may be rotatable in a horizontal plane by a rotating mechanism which includes, for example, a motor as a driving source (not illustrated). Therefore, the antenna 5 may be capable of repeatedly transmitting and receiving radio waves while rotating in the horizontal plane. Moreover, the antenna 5 can transmit and receive the radio waves by changing an elevation angle by the rotating mechanism. Accordingly, the antenna 5 can three-dimensionally scan the observation range of a hemispheric shape. Note that a horizontally polarized reception signal and a vertically polarized reception signal which are reception signals received by the antenna 5 may be outputted to the reception signal processor 13 via the circulator 17.

The reception signal processor 13 may execute signal processing to the reception signal received by the antenna 5. The reception signal processor 13 may include an A/D converter 18, a pulse compression module 19, and a signal noise processing module 20.

The A/D converter 18 may convert the reception signal into a digital signal, and output the digital signal to the pulse compression module 19.

The pulse compression module 19 may perform a pulse compression to the digital signal outputted from the A/D converter 18 so as to improve, for example, a signal-to-noise ratio (S/N ratio) of the reception signal. The signal to which the pulse compression is performed may be outputted to the signal noise processing module 20.

The signal noise processing module 20 may remove noise such as frequency noise. The signal noise processing module 20 may output the signal to which the noise processing is performed to the data processor 21.

Description is given about the data processor 21. The data processor 21 may calculate polarization parameters for respective observation meshes (sampling areas) M which are areas finely dividing the observation range, based on the reception signals inputted from the radar 11.

In this embodiment, the polarization parameters calculated and acquired by the data processor 21 may include the radar reflective factor Zhh and the differential reflective factor Zdr.

The radar reflective factor Zhh may indicate an intensity of a radar reflective wave. The radar reflective factor may be, for example, a reflective intensity when the horizontally polarized wave is transmitted and received (Zhh), or a reflective intensity when the vertically polarized wave is transmitted and received (Zvv). However, in this embodiment, the reflective wave when the horizontally polarized wave is transmitted and received (Zhh) may be used as the radar reflective factor.

The differential reflective factor Zdr may be expressed as a ratio of the reflective intensity of the horizontally polarized wave (Zhh) to the reflective intensity of the vertically polarized wave (Zvv). The differential reflective factor Zdr may indicate an aspect ratio of a precipitation particle. It is known that, when the precipitation particle is rain, a raindrop may become flat by receiving an air resistance as the raindrop becomes larger. Therefore, the differential reflective factor Zdr may be an important parameter in order to estimate a particle size distribution of the raindrop.

The data processor 21 may calculate, as polarization parameters in addition to those described above, correlation coefficient phv, a specific differential phase Kdp, a Doppler velocity Vd, etc.

The data processor 21 may repeat the calculation of the polarization parameters every time a scanning of the observation range for one time is completed by the radar 11, and new reception signals for all the observation meshes M are obtained. Therefore, the polarization parameters for all the observation meshes M in the observation range can be acquired at a given time interval (e.g., every one minute).

The data processor 21 may output the calculated polarization parameters to the output part 41. Moreover, the data processor 21 may output, among the calculated polarization parameters, the radar reflective factors Zhh and the differential reflective factors Zdr to the discriminator 31.

Description is given about the discriminator 31. The discriminator 31 may include a data extracting module 32, an evaluation value calculating module 33, and a discrimination processing module 34.

The data extracting module 32 may extract, from the data inputted into the discriminator 31, data of radar reflective factors Zhh and differential reflective factors Zdr related to observation meshes M included in a given discrimination target range T which is specified in advance, among the observation meshes M dividing the observation range.

The discrimination target range T may be, as illustrated in FIG. 2, a fan-shaped two-dimensional range when seen from above, but not limited to this. For example, since the radar 11 can scan a space three-dimensionally while changing the elevation angle of the antenna 5, the discrimination target range T may be a three-dimensional shape having a fan shape when seen from both above and the side. The term “range” used herein may include both a two-dimensional range and a three-dimensional range.

The data extracting module 32 may output the values of the radar reflective factors Zhh and the values of the differential reflective factors Zdr of observation meshes M included in the discrimination target range T to the evaluation value calculating module 33. Moreover, the data extracting module 32 may output the extracted values of the radar reflective factors Zhh to the discrimination processing module 34.

The evaluation value calculating module 33 may generate distribution data based on the values of the radar reflective factors Zhh and the values of the differential reflective factors Zdr of observation meshes M which are inputted from the data extracting module 32. The evaluation value calculating module 33 may statistically analyze this distribution data so as to calculate an evaluation value V which is used for discriminating the precipitation particles.

The evaluation value calculating module 33 may include a distribution data generating module 35, and a distribution data analyzing module 36.

The distribution data generating module 35 may generate the distribution data which indicates the relationship between the radar reflective factors Zhh and the differential reflective factors Zdr obtained for respective observation meshes M included in the discrimination target range T. This distribution data is a scatter plot, and preferably, a first axis indicates the radar reflective factor, and a second axis indicates the differential reflective factor. Accordingly, the type of the precipitation particles can be discriminated by using the data in which the relationship between the radar reflective factors and the differential reflective factors is further clarified.

Note that, preferably, in order to remove influence of a radar echo reflected on an object other than the precipitation particle (e.g., an echo reflected on a building), and improve the accuracy of discrimination, thresholding may be performed on the data inputted from the data extracting module 32 before the distribution data generating module 35 generates the distribution data. For this thresholding, a suitable radar observation result (e.g., the S/N ratio, the radar reflective factor Zhh, and the differential reflective factor Zdr) may be used. Since this thresholding is a known technique, a detailed description is omitted.

The distribution data analyzing module 36 may perform an analysis, such as a regression analysis, on the distribution data generated by the distribution data generating module 35 in order to calculate the evaluation value V from the distribution data. In this embodiment, the regression analysis may include obtaining an approximated straight line based on the distribution data. However, instead of the straight-line approximation, an approximation using a suitable curved-line may be performed.

A method of obtaining the evaluation value V is described. As illustrated in FIGS. 3(a) and (b), in the scatter plot, a plane XY is defined by an x-axis (a first axis) which indicates the value of the radar reflective factor Zhh, and an y-axis (a second axis) which indicates the value of the differential reflective factor Zdr. On the XY plane, the relationship between the value of the radar reflective factor Zhh and the value of the differential reflective factor Zdr of each observation mesh M is plotted. A unit of the value of the radar reflective factor Zhh is dBZ, and a unit of the value of the differential reflective factor Zdr is dB.

In this embodiment, when an approximated straight line which is obtained by a first-order approximation of the distribution indicated in the scatter plot is expressed as “y=ax+b,” the evaluation value V may be obtained by adding a y-intercept “b” to a value fifty times a slope “a” (V=a×50+b).

Here, in FIGS. 3(a) and (b), relationship between the radar reflective factors Zhh and the differential reflective factors Zdr which are acquired from rain particles and snow particles, are described respectively.

Since rain particles are liquid, they may become flat due to influence of air resistance when the rain particles fall. A degree of flatness may increase as the rain particles become larger. Therefore, a radar echo reflected on the rain particles may have a tendency in which the value of the differential reflective factor Zdr increases as the value of the radar reflective factor Zhh increases. Thus, distribution when the discrimination target range T entirely has rain may be as illustrated in FIG. 3(a).

On the other hand, since snow particles are solid and difficult to deform into a flat shape when they fall, the snow particles may not have the correlation as described above. Therefore, a radar echo reflected on the snow particles may have a tendency in which the value of the differential reflective factor Zdr is approximately constant even when the value of the radar reflective factor Zhh changes. As a result, distribution when the discrimination target range T entirely has snow may be as illustrated in FIG. 3(b).

Based on the above, when considering a straight line which most accurately illustrates the distribution data described above, it can be said that the slope a of the straight line indicates a strength of the tendency in which the value of the differential reflective factor Zdr increases as the value of the radar reflective factor Zhh increases. In other words, as the slop “a” increases, there may be a strong positive correlation between the value of the radar reflective factor Zhh and the value of the differential reflective factor Zdr.

Regarding to this, in this embodiment, since the equation for obtaining the evaluation value V which is used for discriminating the precipitation particles includes the slope a, it may become possible to accurately discriminate whether the precipitation particles are rain particles or snow particles. Moreover, by using the straight line as the approximated line, the strength of the correlation can be evaluated by an easy processing.

Further, in this embodiment, the evaluation value V may be obtained by adding the slope a and the y-intercept b of the approximated straight line while differentiating their weightings so that the influence of the slope becomes fifty times larger than that of the y-intercept. Therefore, both the slope and the y-intercept of the approximated straight line can be evaluated in a balanced manner.

Note that, when comparing the equation for obtaining the evaluation value V and the equation of the approximated straight line, the evaluation value V may be equal to a value of y when x=50 is substituted into the equation (Y=ax+b) of the approximated straight line. FIGS. 3(a) and (b) indicate the method of obtaining the evaluation value on the basis of this aspect. Although the value to be substituted is not limited to x=50, a given value of 40 dBZ or higher and 60 dBZ or lower is preferably substituted. Moreover, a Zhh average value (described later) may be substituted.

However, various methods may be applied for obtaining the evaluation value V, and the method may be changed suitably. For example, the evaluation value V may be a value obtained by adding twice the value of b, to 100 times the value of a.

The distribution data analyzing module 36 in FIG. 1 may calculate the equation of the approximated straight line described above from the distribution data so as to obtain the evaluation value V based on the equation. As a method of obtaining the equation of the approximated straight line, for example, a known least-squares method may be used. The distribution data analyzing module 36 may output the calculated evaluation value V to the discrimination processing module 34.

In the least-squares method, the approximated straight line may be obtained such that a sum of squares of residual errors becomes the minimum. When the size of the residual errors (e.g., a value obtained by dividing the sum of squares of the residual errors by a number of data) is above a threshold, this means that the obtained straight line may not appropriately approximate the distribution for some reason such as influence of noise. Therefore, in this case, in order to avoid a decrease in the accuracy of the discrimination, the type of precipitation is preferably excluded from the object to be discriminated.

The discrimination processing module 34 may discriminate the type of the precipitation particles existing in the discrimination target range T, based on a value which is an average of the values of the radar reflective factors Zhh in the observation meshes M, and the evaluation value V outputted from the evaluation value calculating module 33.

The discrimination processing module 34 may include a reflective factor average calculating module 37, and a particle discriminating module 38.

The reflective factor average calculating module 37 may receive the input of the values of radar reflective factors Zhh for the observation meshes M included in the discrimination target range T, and calculate the average of the values. This average value can be a representative value in the distribution of the values of the radar reflective factors Zhh. The reflective factor average calculating module 37 may output the average value of the radar reflective factors Zhh (hereinafter, referred to as a “Zhh average value”) to the particle discriminating module 38.

The particle discriminating module 38 may discriminate the type of the precipitation particles existing in the discrimination target range T, based on the Zhh average value outputted from the reflective factor average calculating module 37, and the evaluation value V outputted from the distribution data analyzing module 36. The particle discriminating module 38 may output the discrimination result to the output part 41.

A discrimination performed by the particle discriminating module 38 is described in detail. When a given discrimination target range T has rain and snow, a scatter plot where relationship between the Zhh average values and the evaluation values based on actual observation results is plotted, is as illustrated in FIG. 4. It can be seen that a distribution range of a rain data group and a distribution range of a snow data group are separated nearly clearly. In this embodiment, a discriminant function corresponding to a border B which separates the two ranges may be obtained in advance based on the observation, and the discriminant function may be set in advance in the particle discriminating module 38. In this embodiment, this discriminant function may be a two-variable function having the Zhh average value and the evaluation value as variables. In this embodiment, as illustrated in FIG. 4, since the two data groups may be linearly separable, the discriminant function may be a linear function. Note that the discriminant function may be a curved function instead of the linear function, as long as the discriminant function is a function which defines a threshold for determining the type of the precipitation particles. Since the ranges of the data groups are separated clearly, the discrimination can be performed accurately by using the simple discriminant function.

When the particle discriminating module 38 receives the input of the combination of the average value of radar reflective factors Zhh, and the evaluation value V based on a new observation, the particle discriminating module 38 may discriminate the type of the precipitation particles based on a sign of a calculation result obtained by substituting the average value of radar reflective factors Zhh and the evaluation value V into the discriminant function. In detail, when the sign of the discriminant function is plus, the particle discriminating module 38 may determine that the precipitation particles are “rain,” and when the sign is minus, the particle discriminating module 38 may determine that they are “snow.”

When the discrimination target range T has snow, the reflective intensity of the radio wave may be extremely small, and thus securing a suitable S/N ratio may be difficult. Regarding to this, since the discriminant function as described above is used in this embodiment, as illustrated in the scatter plot of FIG. 4, an accurate discrimination between rain and snow may be possible even when the Zhh average value is 20 dBZ or below. Therefore, the type of the particles existing in the discrimination target range T can be stably and accurately discriminated under various weather conditions.

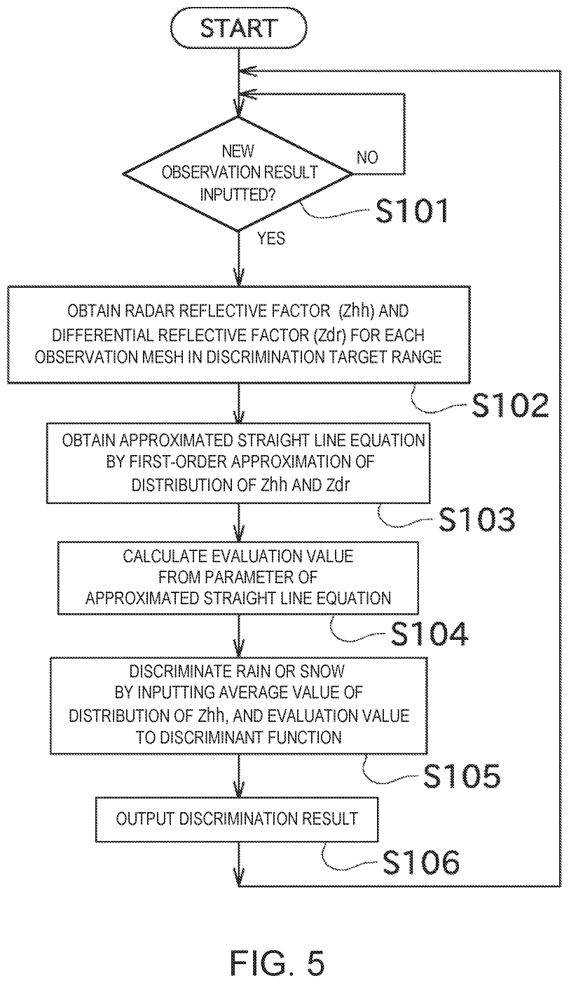

Next, processing executed by a precipitation particle discriminating program is described with reference to FIG. 5. FIG. 5 is a flowchart illustrating processing executed by the weather radar device 1.

When the processing starts, the weather radar device 1 may stand by until the data processor 21 acquires a new reception signal, and the discriminator 31 may receive an input of new observation data (polarization parameters) from the data processor 21 (Step S101).

When the discriminator 31 receives the input of the new observation data, the data extracting module 32 may extract values of the radar reflective factors Zhh and values of the differential reflective factors Zdr related to the observation meshes M in the discrimination target range T (Step S102).

Next, the distribution data generating module 35 of the evaluation value calculating module 33 may generate the distribution data indicative of the relationship between the radar reflective factor Zhh and the differential reflective factor Zdr of each observation mesh M. Moreover, the distribution data analyzing module 36 of the evaluation value calculating module 33 may calculate the equation of the approximated straight line which approximates the distribution data (Step S103). Then, the distribution data analyzing module 36 may calculate the evaluation value from the equation of the approximated straight line (Step S104).

When the evaluation value is obtained, the particle discriminating module 38 may discriminate the type of the precipitation particles existing in the discrimination target range T by using the discriminant function, based on the Zhh average value calculated by the reflective factor average calculating module 37 and the evaluation value (Step S105). The discriminator 31 may output the obtained discrimination result to an external device via the output part 41 (Step S106). Then the processing may return to Step S101.

This program may cause the computer to execute a precipitation particle discrimination step. The program may include an acquiring step (Step S101) where the horizontally polarized reception signals and the vertically polarized reception signals are acquired by transmitting and receiving the horizontally polarized waves and the vertically polarized waves, respectively, a data processing step (Step S101) where information on the radar reflective factors and information on the differential reflective factors which are the polarization parameters calculated based on the horizontally polarized reception signals and the vertically polarized reception signals are acquired, a distribution data generating step (Steps S102 and S103) where the distribution data indicative of the relationship between the radar reflective factor information and the differential reflective factor information in a plurality of sampling ranges included in the discrimination target range is generated, an distribution data analyzing step (Steps S103 and S104) where the evaluation value which is used for discriminating the type of the precipitation particles is calculated based on the distribution data, and a discrimination processing step (Step S105) where the type of the precipitation particles existing in the discrimination target range is discriminated based on the evaluation value.

In this embodiment, since the discrimination is performed by obtaining the approximated straight line from the scatter plot of the data, a certain number of data is required. However, according to a trial calculation by the present inventor, with the configuration of this embodiment, the discrimination between rain and snow can be performed with a sufficient accuracy by securing less than half the number of data (e.g., approximately 40) required in the conventional method.

As described above, the weather radar device 1 may include the radar 11, the data processor 21, the distribution data generating module 35, the distribution data analyzing module 36, and the discrimination processing module 34. The radar 11 may acquire the horizontally polarized reception signals and the vertically polarized reception signals by transmitting and receiving the horizontally polarized waves and the vertically polarized waves, respectively. The data processor 21 may acquire the information on the radar reflective factors and the information on the differential reflective factors which are the polarization parameters calculated based on the horizontally polarized reception signals and the vertically polarized reception signals. The distribution data generating module 35 may generate the distribution data indicative of the relationship between the radar reflective factor information and the differential reflective factor information in a plurality of observation meshes M included in the discrimination target range T. The distribution data analyzing module 36 may calculate the evaluation value V which is used for discriminating the type of the precipitation particles based on the distribution data. The discrimination processing module 34 may discriminate the type of the precipitation particles existing in the discrimination target range T based on the evaluation value V.

That is, a liquid precipitation particle may have the tendency that the value of the differential reflective factor Zdr increases as the value of the radar reflective factor Zhh increases, while a solid precipitation particle rarely has such a tendency. Therefore, by the intensity of the correlation between the value of the differential reflective factor Zdr and the value of the radar reflective factor Zhh being evaluated, the type of the precipitation particles can be discriminated suitably.

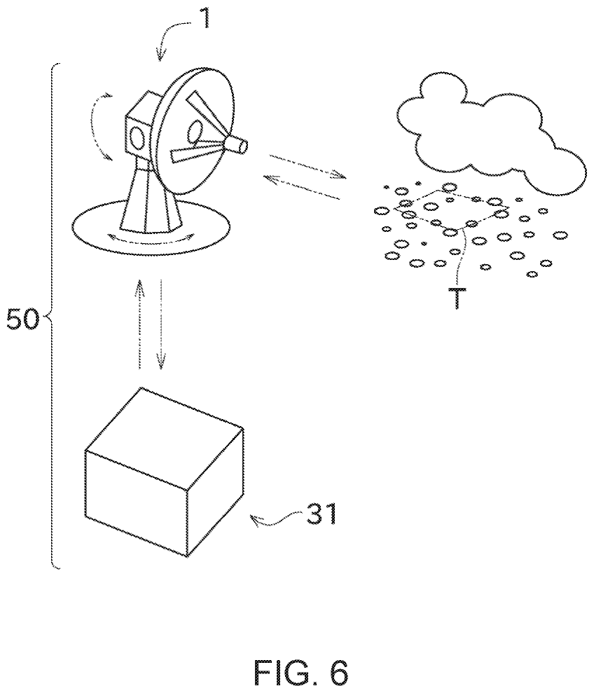

Next, a modification of the above embodiment is described. FIG. 6 is a view illustrating a precipitation particle discriminating system 50 according to this modification. Note that in the description of this modification, description of components the same as or similar to those of the above embodiment may be omitted, while denoting the components the same reference characters in the drawing.

In the modification illustrated in FIG. 6, the discriminator 31 may be provided separately from the weather radar device 1. In this modification, the discriminator 31 may function as the precipitation particle discriminator of the present disclosure. The weather radar device 1 and the discriminator 31 can communicate with each other via a WAN, etc. The precipitation particle discriminating system 50 may be implemented by the weather radar device 1 and the discriminator 31. The similar effects as the above embodiment can be achieved by the configurations of this modification.

Although the suitable embodiment and the modification of the present disclosure are described above, the above configurations may be changed as follows, for example.

The evaluation value V may be calculated using a correlation coefficient between the radar reflective factors and the differential reflective factors, instead of using the slope and the intercept of the approximated straight line described above. Moreover, the strength of the correlation between the radar reflective factors and the differential reflective factors, and other parameters may be evaluated comprehensively so as to discriminate the type of the precipitation particles.

As the radar reflective factor, the reflective intensity when the vertically polarized wave is transmitted and received (Zvv) may be used instead of the reflective intensity when the horizontally polarized wave is transmitted and received (Zhh).

Instead of the Zhh average value, another representative value, for example, the median of Zhh may be used so as to discriminate the type of precipitation particles.

The present disclosure may be used for discriminating the precipitation particles not only between rain and snow, but also between other types. For example, the present disclosure may be used for discriminating the precipitation particles between dry snow, wet snow, snow hail, etc., among the snow particles.

The frequency band of the radio waves transmitted and received by the weather radar device 1 may be changed to C-band, S-band, etc.

The weather radar device 1 and the discriminator 31 may suitably be disposed on a structure. For example, the weather radar device 1 and the discriminator 31 may be provided to a building or a moving body.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Unless otherwise noted, numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A precipitation particle discriminator, comprising:
a radar antenna configured to acquire horizontally polarized reception signals and vertically polarized reception signals by transmitting and receiving horizontally polarized waves and vertically polarized waves, respectively; and
processing circuitry configured to:
acquire information on radar reflectivity and information on differential reflectivity that are polarization parameters calculated based on the horizontally polarized reception signal and the vertically polarized reception signal;
generate distribution data indicative of relationship between the radar reflectivity information and the differential reflectivity information in a plurality of sampling ranges included in a discrimination target range;
calculate an evaluation value used for discriminating a type of precipitation particles based on the distribution data; and
discriminate the type of the precipitation particles existing in the discrimination target range based on the evaluation value.

2. The precipitation particle discriminator of claim 1, wherein the evaluation value is a value derived based on information indicating strength of correlation between the radar reflectivity information and the differential reflectivity information.

3. The precipitation particle discriminator of claim 1 wherein the evaluation value is calculated using an approximated line of the distribution data.

4. The precipitation particle discriminator of claim 3, wherein the approximated line is a straight line, and the evaluation value is calculated at least using a slope of the straight line.

5. The precipitation particle discriminator of claim 4, wherein the evaluation value is calculated further using an intercept of the straight line.

6. The precipitation particle discriminator of claim 5, wherein the evaluation value is calculated by a weighted addition of the slope and the intercept of the straight line.

7. The precipitation particle discriminator of claim 3, wherein the evaluation value is a value of the differential reflectivity information on the approximated line, when a value of the radar reflectivity information is a given value of 40 dBZ or higher and 60 dBZ or lower.

8. The precipitation particle discriminator of claim 3, wherein the evaluation value is a value of the differential reflectivity information on the approximated line, corresponding to an average of values of the radar reflectivity information in the distribution data.

9. The precipitation particle discriminator of claim 3, wherein the processing circuitry discriminates when a deviation of the distribution data from the approximated line is smaller than a given amount.

10. The precipitation particle discriminator of claim 1, wherein the processing circuitry is further configured to discriminate the type of the precipitation particles based on a discriminant function having, as variables, a representative value that represents values of the radar reflectivity information comprising the distribution data, and the evaluation value.

11. The precipitation particle discriminator of claim 1, wherein the distribution data is a scatter plot where a first axis indicates the radar reflectivity, and a second axis indicates the differential reflectivity.

12. The precipitation particle discriminator of claim 1, wherein the discrimination by the processing circuitry includes discriminating whether the precipitation particles are rain or snow.

13. The precipitation particle discriminator of claim 1, wherein the processing circuitry is further configured to extract the radar reflectivity information and the differential reflectivity information in the plurality of sampling ranges included in the discrimination target range within an observation range, from the radar reflectivity information and the differential reflectivity information that are the polarization parameters calculated and acquired by the processing circuitry based on the horizontally polarized reception signals and the vertically polarized reception signals,
wherein the processing circuitry is further configured to generate the distribution data based on the radar reflectivity information and the differential reflectivity information.

14. The precipitation particle discriminator of claim 2 wherein the evaluation value is calculated using an approximated line of the distribution data.

15. The precipitation particle discriminator of claim 14, wherein the approximated line is a straight line, and the evaluation value is calculated at least using a slope of the straight line.

16. The precipitation particle discriminator of claim 15, wherein the evaluation value is calculated further using an intercept of the straight line.

17. The precipitation particle discriminator of claim 16, wherein the evaluation value is calculated by a weighted addition of the slope and the intercept of the straight line.

18. The precipitation particle discriminator of claim 14, wherein the evaluation value is a value of the differential reflectivity information on the approximated line, when a value of the radar reflectivity information is a given value of 40 dBZ or higher and 60 dBZ or lower.

19. A precipitation particle discriminating method, comprising:
acquiring horizontally polarized reception signals and vertically polarized reception signals by transmitting and receiving horizontally polarized waves and vertically polarized waves, respectively;
acquiring information on radar reflectivity and information on differential reflectivity that are polarization parameters calculated based on the horizontally polarized reception signals and the vertically polarized reception signals;
generating distribution data indicative of relationship between the radar reflectivity information and the differential reflectivity information in a plurality of sampling ranges included in a discrimination target range;
calculating an evaluation value used for discriminating a type of precipitation particles based on the distribution data; and
discriminating the type of the precipitation particles existing in the discrimination target range based on the evaluation value.

20. A non-transitory computer-readable recording medium storing a control program causing a processor of a precipitation particle discriminator to execute processing, the processor configured to control operation of the device, the processing comprising:
generating distribution data based on information on radar reflectivity and information on differential reflectivity that are polarization parameters calculated based on horizontally polarized reception signals and vertically polarized reception signals obtained by transmitting and receiving a horizontally polarized wave and a vertically polarized wave, respectively, the distribution data indicating relationship between the radar reflectivity information and the differential reflectivity information in a plurality of sampling ranges included in a discrimination target range;
calculating, based on the distribution data, an evaluation value indicating strength of correlation between the radar reflectivity information and the differential reflectivity information; and
discriminating a type of precipitation particles existing in the discrimination target range based on the evaluation value.
